(19) United States
(12) Patent Application Publication
(10) Pub. No.: US 2019/0059350 A1
(43) Pub. Date: Feb. 28, 2019

(54) INSECT DETACHMENT SYSTEM FOR UPSTANDING VEGETATION

(71) Applicant: Majid Haghoo, Woodland Hills, CA (US)

(72) Inventor: Majid Haghoo, Woodland Hills, CA (US)

(21) Appl. No.: 16/113,984

(22) Filed: Aug. 27, 2018

Related U.S. Application Data
(60) Provisional application No. 62/551,108, filed on Aug. 28, 2017.

(51) Int. Cl. A01M 7/00; B05B 1/30

(52) U.S. Cl. CPC A01M 7/0032; B05B 1/14; B05B 1/30; A01M 7/006

(57) ABSTRACT

A fluid dispenser that is arranged with rotating gimbals supporting nozzles at multiple altitudes that can rinse and remove insects from the trees without harming the fruit or the trees. A vertical standpipe connected to a water supply leads to a flexible tubing over the top of the tree, with an umbrella or parabolic frame supporting multiple conduits terminating in gimballed nozzles about the tree that can be adjusted and aimed to stream water from the water source directly onto the tree via the vertical standpipe. Each conduit supports a gimballed nozzle that can be adjusted so that the stream can be focused at the areas where insects collect.

### CROSS-REFERENCES TO RELATED APPLICATIONS

This application claims priority from U.S. Provisional Patent Application No. 62/551,108, filed Aug. 27, 2017, the content of which is fully incorporated herein by reference.

### BACKGROUND

All deciduous fruit trees suffer from either intermittent to more continuous infestations of insects that affect both the health of the trees and the quality of the fruit. From peach twig borers to apple maggots, there seems to be at least one bug that threatens the health and yield of every kind of fruit tree. One prominent insect that attacks a large number of fruit trees are aphids, tiny, pinhead-sized insects that vary in color depending on the type. These insects cluster on the stems and under leaves of the fruit trees, sucking plant juices and negatively impacting the growing processes of the trees. Tree owners know well the symptoms of aphids, namely curled leaves that thicken, yellow, and die. Aphids also produce large amounts of a sticky residue called “honeydew” that attracts insects like ants. Honeydew becomes a growth medium for sooty mold.

Some bug problems can be contained by hand-picking the bugs themselves or even the sections of fruit trees which they are infesting. Caterpillars threaten fruit trees by working their way into fruits or by infecting them with fecal matter. Larger insects such as these can be manually removed from the tree if spotted. Scales, which look like a lumpy disease but are actually large clusters of tiny bugs, can destroy young trees and damage fruit by excreting a substance known as honeydew onto them. Scales can be removed by scrubbing the infected plant parts with soapy water. However, manual removal is not a practical option for either large number of fruit trees or a high degree of infestation, as the amount of labor required becomes extensive.

Chemical sprays are also known to address different kinds of pest problems on fruit trees, including several organic options. Neem oil, made from the seeds of the Indian neem tree (Azadirachta indica), fights off a range of fruit tree pests, including aphids and scales. Sprays derived from bacterial disease attack fruit predators. Different strains of Bacillus thuringiensis, or Bt, kill specific strains of pests and are so targeted that “good” bugs are spared, as are larger animals. These sprays may be helpful against fruit tree pests, especially caterpillars and fruit worms. Dormant oil sprays coats fruit trees in the winter, smothering emerging pest such as the peach twig borer. Insecticidal soap sprays kills insects such as aphids on contact. However, such sprays can be expensive, require repeated applications, and may damage or become absorbed into the fruit. Thus, a better option is needed.

Sticky traps have also been attempted for trapping and killing fruit tree pests. Traps colored and shaped like apples have been shown to be effective against the apple tree maggot. Yellow sticky traps are sometimes effective against cherry fruit flies. Additionally, commercial pheromone traps have been attempted for fruit tree pests, including peach twig borers and apple maggots. Manufactures make traps using as a lure capsules filled with sex hormones called pheromones that attract specific pests. Use pheromone traps not only to kill these pests but to confirm what the pests are, as well as when they are striking your fruit trees. However, these traps often attract as many pests as they deter, and the traps must be attended to, emptied, replaced, or otherwise serviced on a regular basis.

The art is in need of a system that works on all types of fruit trees, regardless of type and irrespective of insect, and works without impacting the fruit or using chemicals or pheromones. The present invention solves all of the shortcomings of the prior art and presents a reliable, cost-effective system for detaching and expelling insects from fruit trees in a safe and rapid manner.

### SUMMARY OF THE INVENTION

The present invention is a fluid dispenser that is arranged with rotating gimbals supporting nozzles at multiple altitudes that can rinse and remove insects from the trees without harming the fruit or the trees. A vertical standpipe connected to a water supply leads to a flexible tubing over the top of the tree, with an umbrella or parabolic frame supporting multiple conduits terminating in gimballed nozzles about the tree that can be adjusted and aimed to stream water from the water source directly onto the tree via the vertical standpipe. Each conduit supports a gimballed nozzle that can be adjusted so that the stream can be focused at the areas where insects collect. The system can support as many nozzles and as many conduits as needed to rinse the tree and remove the insects, and the water supply and pipe/conduit sizing is selected based on the requirements of each system (height, # of nozzles, stream intensity, etc.). The invention can also be used on other types of trees, bushes (e.g., rose bushes that attract aphids), and shrubs that attract insects in the same manner as above.

These and other features of the present invention will best be understood by reference to the drawings and the detailed description of the invention below.

### BRIEF DESCRIPTION OF THE DRAWINGS

FIG. 1 is a side view of a first embodiment of the present invention;

FIG. 2 is an enlarged, elevated perspective view of a shut-off valve of the present invention;

FIG. 3A is an elevated perspective view of a plant prior to debugging; and

FIG. 3B is an elevated perspective view of the plant after debugging.

### DETAILED DESCRIPTION OF THE PREFERRED EMBODIMENTS

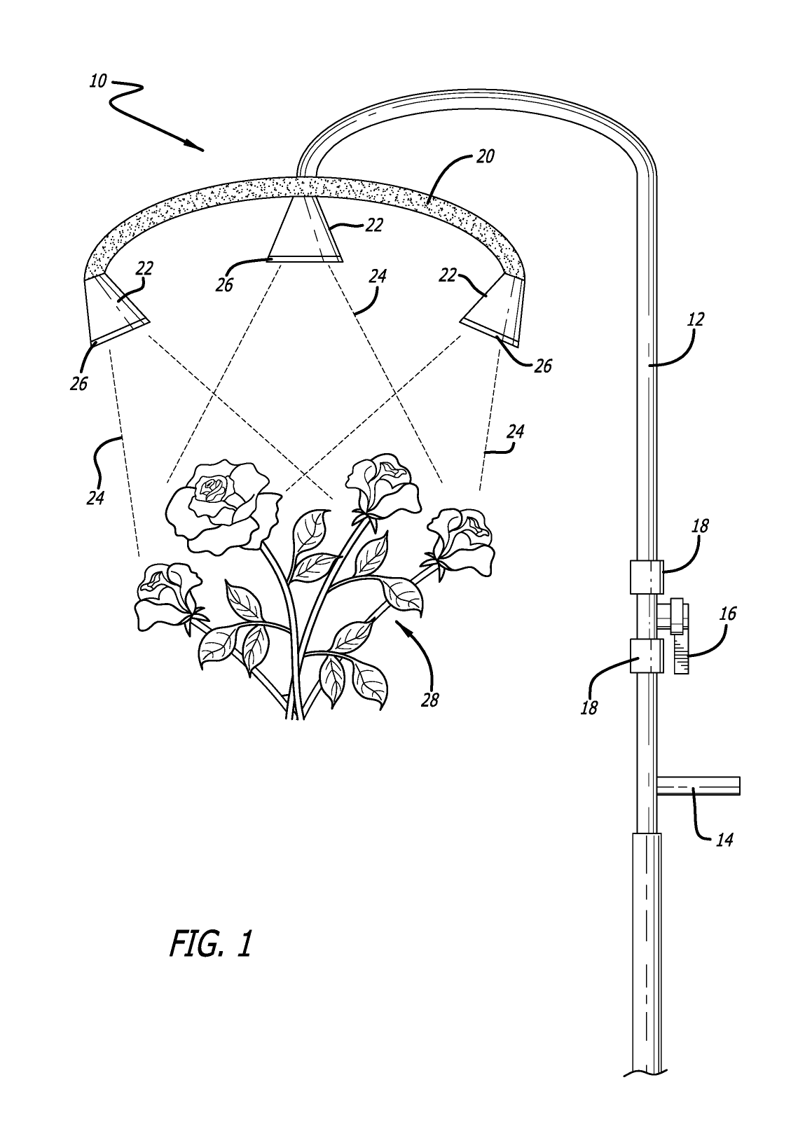

FIG. 1 illustrates a first preferred embodiment of the system of the present invention, comprising a non-destructive plant debugging system 10. The device includes a vertical standpipe 12 has been erected after it has been connected to the water supply (not shown) such as a hose. In the embodiment shown, a handle 14 comprising a cylindrical rod extending perpendicular to the standpipe 12 can be used for grasping the device and for securing the device in the ground. A flow control valve 16 is shown above the handle 14, and it is understood that the valve 16 can be opened and closed either manual or by automatic elements. The vertical standpipe 12 in a preferred embodiment is made of a sturdy, lightweight material such as polyvinyl chloride, aluminum, or the like, and incorporates a telescoping series of segments that allow the standpipe 12 to adjust to different heights so that different size trees and bushes can be accommodated. For most fruit trees, a vertical standpipe that can extend telescopically from six feet to twelve feet will suffice, but other sizes are clearly also intended to be included within the scope of the invention. A set of locking collars 18 may be included to fix the telescoping pole in a desired position once the correct height is obtained, or other methods can be used to fix the height of the vertical standpipe.

At the top of the vertical standpipe is a U-shaped portion preferably constructed of a flexible tube that arches over the tree 28 and carries water to a fill conduit 20. At the end of the fill conduit 20 are three or more gimballed nozzles 22 that can be adjusted to direct a water stream 24 onto the tree with sufficient force to remove any insects in the path of the stream. The nozzles are gimballed at the end of the fill conduit 20 so that they may be rotated vertically and horizontally to adjust the direction of the stream as needed. The nozzles 22 may also be equipped with an adjustment mechanism 26 that widens or narrows the jet stream 24 to increase the intensity or the area of impact of the stream, depending upon the needs of the user.

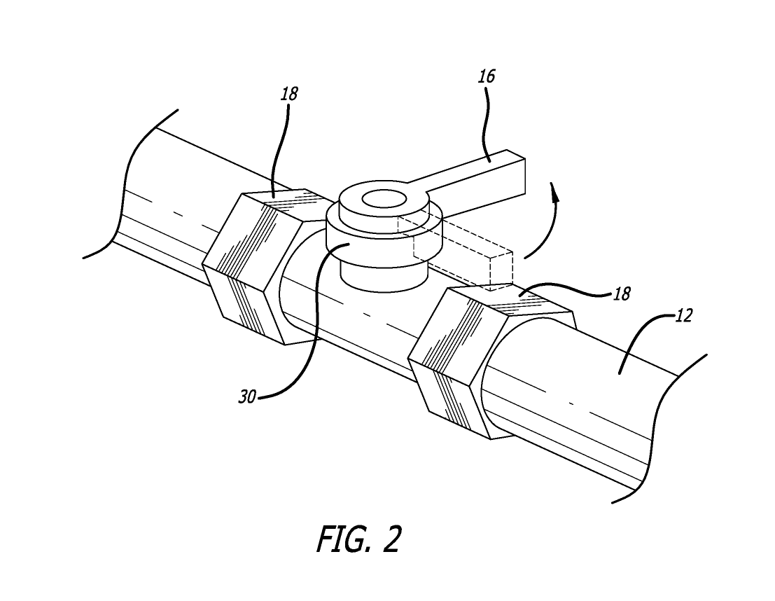

FIG. 2 illustrates an example of a flow control valve 16 on the standpipe 12 of the present invention. The valve 16 opens and closes a flow of water from a water supply such as a water main or sprinkler system. The valve may be manually controlled or automatically operated by a servo or stepper motor 30 to open at certain times throughout the day. When the valve 16 is open, water flows through the standpipe 12 and may be distributed through the system and applied directly to the tree 28.

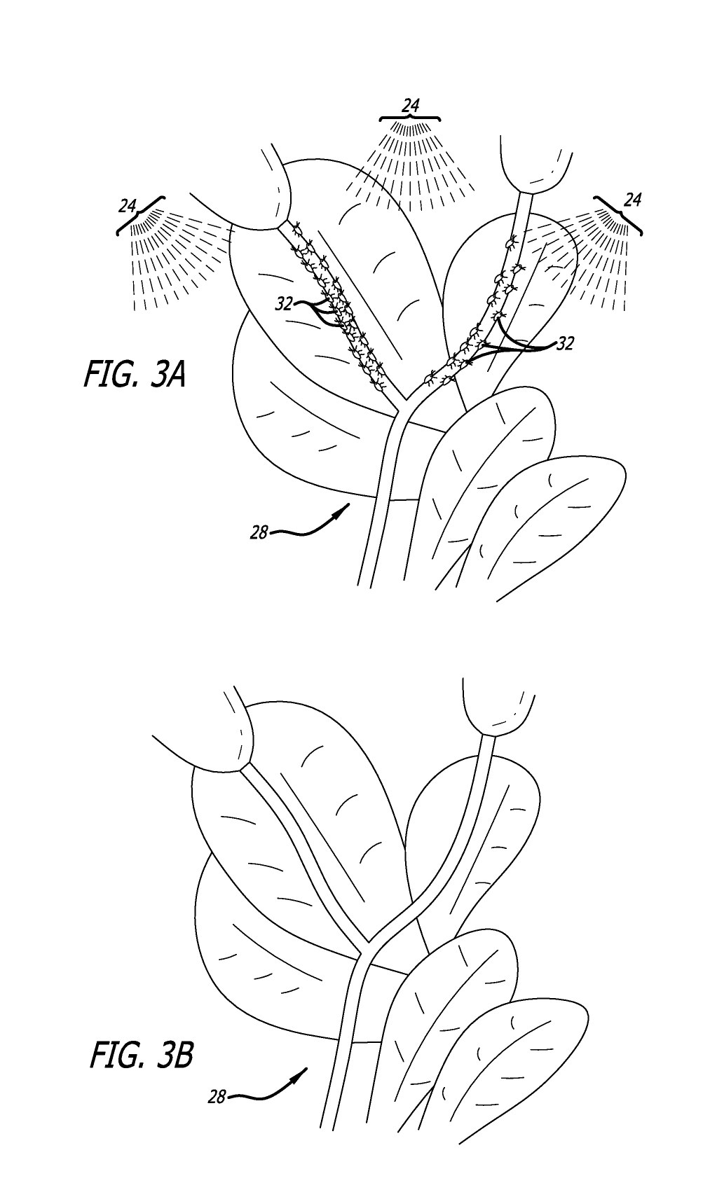

As FIGS. 3A and 3B illustrate, insects 32 on the stems 34 of the trees 28 can be easily removed without damaging the leaves or fruit on the trees. Insects of every time can be quickly removed by the jet stream 24 applied by the nozzles 22, using a modulated water pressure set for the particular application. Water 24 is focused directly on the affected areas, so water is not wasted and the water falls to the ground where it is absorbed by the soil and used by the tree.

The present invention solves many of the issues of the prior art in an environmentally friendly, safe, and effective manner. Using only water, the system can quickly remove aphids, beetles, and other pests from fruit trees quickly without undue effort from the tree owners, and can be used over and over again with little maintenance. No chemicals are needed, no materials need to be replenished, no traps need to be serviced or replaced, and the water that is used to remove the insects can serve the dual purpose of irrigation of the trees that would have already been necessary. The invention also works on dormant trees to protect them from insects that attack the branches or trunk of the tree, as well as bushes such as rose bushes and shrubs.

While the present invention has been depicted in one form, it is to be understood that many different shapes and sizes can be used without departing from the present invention. Moreover, nothing in this disclosure is intended to imply any required material or specific dimension or arrangement other than those expressly recited. It is understood that one of ordinary skill in the art would readily recognize that many modifications could be made to the foregoing descriptions, and the invention is intended to include all such modifications.

I claim:

1. An insect removal system for a tree, comprising:
a supply of water;
a telescoping standpipe having a length that extends between six and twelve feet and connected to the supply of water;
a flow control valve controlling a flow of water through the standpipe;
a flexible U-shaped tube at the top of the telescoping standpipe and fluidly connected to a fill conduit;
a plurality of gimballed nozzles fluidly connected to the fill conduit, the gimballed nozzles each including a flow stream adjustment device; and
a handle perpendicularly extending from the telescoping standpipe.

2. The insect removal system of claim 1, wherein the standpipe is plastic.

3. The insect removal system of claim 1, wherein the flow control valve is operated by a motor.

4. The insect removal system of claim 3, wherein the motor is a servo motor.

5. The insect removal system of claim 3, wherein the motor is a stepper motor.
